(19) United States
(12) Patent Application Publication
(10) Pub. No.: US 2022/0227501 A1
(43) Pub. Date: Jul. 21, 2022

(54) CARRIER WITH MOVABLE FAN BLADE HOLDERS

(71) Applicant: TÜRK HAVA YOLLARI TEKNIK ANONIM SIRKETI, Istanbul (TR)

(72) Inventor: Bayram Tuna KEKEÇ, Istanbul (TR)

(21) Appl. No.: 17/616,508

(22) PCT Filed: Nov. 20, 2020
(86) PCT No.: PCT/TR2020/051141

§ 371 Date: Dec. 3, 2021

(30) Foreign Application Priority Data
Apr. 15, 2020 (TR) 2020/05987

(51) Int. Cl. B64F 5/50; F01D 25/28

(52) U.S. Cl. CPC B64F 5/50; F01D 25/285

(57) ABSTRACT

The present invention particularly relates to a carrier with movable fan blade holders (2) that can swivel independently in the vertical axis so as to carry and pile up the fan blades and mating parts to be removed from engines or to be mounted thereto during performing maintenance of aircraft engines or repairing process. Furthermore, it is ensured by means of the present invention to index holders (2) through an index mechanism (7) and to fasten the fan blades to holders (2) through a belt (4).

### TECHNICAL FIELD

The present invention generally relates to a carrier with movable fan blade holders to carry and pile up fan blades and mating parts to be removed from aircraft engines or to be mounted to the engines.

The present invention particularly relates to a carrier with movable fan blade holders that can swivel independently in the vertical axis so as to carry and pile up the fan blades and mating parts to be removed from engines or to be mounted thereto during performing maintenance of aircraft engines or repairing process. Furthermore, it is ensured by means of the present invention to index holders through a pin mechanism and to fasten the fan blades to holders through a belt.

### STATE OF THE ART

In the state of the art, it is a very exhausting process to remove and carry fan blades in case of aircraft engines breaking down or maintenance and also to mount the repaired or new fan blade to its position. It is wasted a significant amount of space in piling up fan blades due to the dead space between fan blades with an uneven structure formed by being bent spirally according to the blade width so as to ensure air passage, because the carriers in the state of the art are the type of carriers, wherein holders are stable and it is not possible to stock in said dead space.

In the application no. TR 2012/10267 in the state of the art, it is disclosed a carrier platform for mounting and maintaining wing type aircraft engines. The invention relates to a carrier platform that can be adjusted vertically, horizontally, angularly, and globally in various axis and is designed to be used demounting, maintaining, and re-mounting the wing type aircraft engines. For this purpose, the platform comprises generally an engine holding frame, a lower frame allowing the platform for movement by means of wheels thereunder, an axial movement group that can turn right or left on the axial movement guide, an X-Y linear movement group, female holder group and global adapter group driven by the global driving system. However, it should be noted that said invention is designed to be used in demounting an engine complex, not the fan blades. Therefore, it has a low silhouette that is very close to the ground. Said invention does not disclose movable fan blade holders that can swivel independently.

In the application with publication number CN106628877A being another document in the state of the art, it is disclosed a transportation maintenance platform of a fan blade of a large aircraft engine. The transportation maintenance platform comprises a bottom plate, a rotary table, a coaming, and transportation wheels, wherein the transportation wheels are fixed to the lower surface of the bottom plate, the rotary table comprises a support column, an upper chuck, and a lower chuck, the support column is rotatably supported to the upper surface of the bottom plate, the upper chuck and the lower chuck are coaxially fixed to the support column respectively, the distance between the upper chuck and the lower chuck corresponds to the size of the fan blade, a certain distance is kept between the lower chuck and the upper surface of the bottom plate, indexing mechanisms which are used for indexing the upper and lower parts of the fan blade are arranged on the rotary table, and the fan blade is hung on the rotary table and rotates along with the rotary table. The transportation maintenance platform has the advantages of convenience in maintenance and safety in the transportation of the fan blade of the large aircraft engine. It is mentioned in the application that the upper chuck and lower chuck are coaxially fixed to the support column. In the application, holders, to which the fan blades are to be affixed, cannot move independently in the vertical axis because of this fixed embodiment. Herein, it is achieved a holder structure by means of two discs superposed and said two discs can rotate coaxially around a single axis as a whole with holders. It is to be noted that each holder cannot swivel independently from discs and other holders. Yet, in the present invention, each holder can swivel and thereby perform an angular rotation.

As a result, due to the aforementioned drawbacks and insufficiency of the existing solutions regarding the subject matter, the need for development in the related technical field has arisen.

### OBJECT OF THE INVENTION

The invention is created by being inspired by the present situations and aims to solve the problems mentioned above.

The main object of the present invention to provide a carrier with movable fan blade holders that allow fan blades and mating parts demounted from aircraft engines or to be mounted to the engines for achieving a loading/discharging position, thereby allowing for easy loading or taking from the carrier or piling up thereof.

Another object of the present invention is to provide a carrier with movable fan blade holders that can swivel independently in the vertical axis so as to carry and pile up the fan blades and mating parts to be removed from engines or to be mounted thereto during performing maintenance of aircraft engines or repairing process.

Another object of the present invention is to provide a carrier with movable fan blade holders, wherein the fan blades are approached to each other during piling up them, because holders are movable, thereby saving the dead space between the fan blades. Thus, it is also presented a carrier that is significantly lighter and more durable.

In order to achieve the above-mentioned objects, the present invention is a carrier for carrying and piling up the fan blades demounted from aircraft engines or to be mounted to the engine, wherein it comprises at least one holder, to which the fan blades are fixed, that comprises the following,
at least one mast that is comprised of at least two superposed plates and maintains the carrier vertically,
at least one hole bored on plates of said mast,
at least one holder strut that can swivel independently in the holes by being positioned in said holes through lower and/or upper ends,
at least one base that extends outwards from the lower end of said holder strut and to which the lower portion of the fan blade is positioned,
at least one reclining component that extends outwards from the upper end of said holder strut and to which the upper portion of the fan blade is positioned.

Structural and characteristic specifications and all advantages of the invention will be understood more clearly by means of following figures and a detailed description written by making references to these figures and therefore, assessment should be done by taking into consideration these figures and detailed description.

### FIGURES FOR A BETTER UNDERSTANDING OF THE INVENTION

FIG. 1 is a representative perspective view of the carrier with the inventive movable fan blade holders.

FIG. 2A is a representative perspective view of the holder of the carrier with the inventive movable fan blade holders.

FIG. 2B is a representative perspective view of the holder of the carrier with the inventive movable fan blade holders.

FIG. 2C is a representative perspective view of the holder of the carrier with the inventive movable fan blade holders.

FIG. 3 is a representative perspective view of the carrier with the inventive movable fan blade holders.

FIG. 4 is a representative perspective view of the carrier with the inventive movable fan blade holders.

FIG. 5 is a representative perspective view of the carrier with the inventive movable fan blade holders.

FIG. 6 is a view of the connection of the lower end of the holder of the carrier with the inventive movable fan blade holders.

FIG. 7A is a view of the connection of the upper end of the holder of the carrier with the inventive movable fan blade holders.

FIG. 7B is an unindexed view of the index mechanism of the carrier with the inventive movable fan blade holders.

FIG. 7C is an indexed view of the index mechanism of the carrier with the inventive movable fan blade holders.

### DESCRIPTION OF PART REFERENCES

1. Mast
   1.1 Hole
2. Holder
   2.1 Holder strut
   2.2 Base
   2.3 Reclining component
   2.4 Joint
3. Shelf
   3.1 Perforated block
4. Belt
   4.1 Belt Hanger
5. Pocket
6. Lower plate
   6.1 Wheel
   6.2 Handle
7. Index mechanism
   7.1 Index shaft mounting component
   7.2 Index shaft
   7.3 Index shaft mechanism
   7.4 Index head
   7.5 Index shaft housing
   7.6 Index shaft housing mounting component

### DETAILED DESCRIPTION OF THE INVENTION

In this detailed description, the inventive carrier with movable fan blade holders (2) is described only for a better understanding of the subject, such that it constitutes no limiting effect on the scope of the invention.

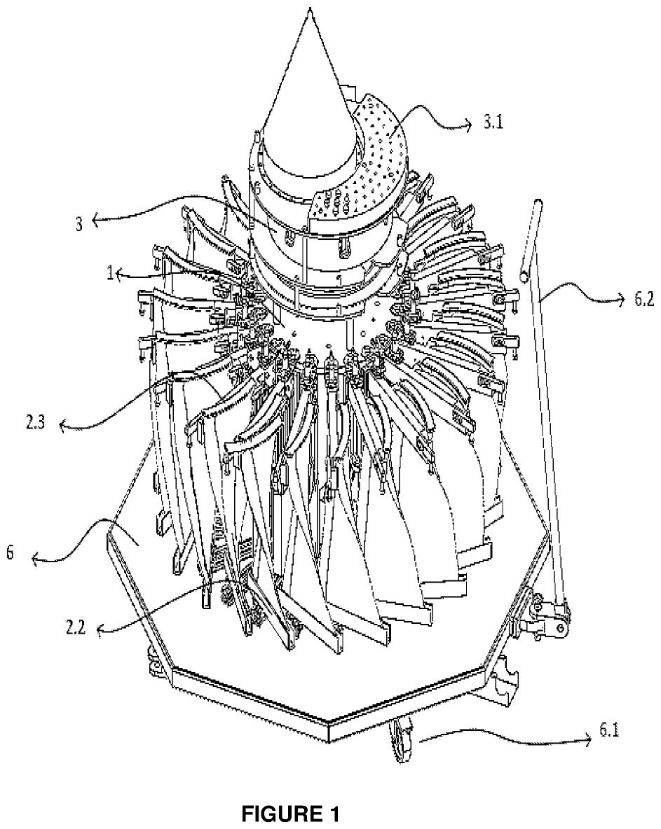

FIG. 1 is a representative view of the carrier designed to carry and pile up the fan blades demounted from aircraft engines and to be mounted to the engines. The inventive carrier comprises holder (2), to which the fan blades are affixed, that comprises the mast (1) comprised of preferably two annular plates positioned preferably coaxially in a superposed manner and maintaining the carrier vertically, wherein there is preferably a strut therebetween, holes (1.1) bored preferably oppositely on the plates of said mast (1) and a holder strut (2.1) that can swivel independently in the holes (1.1) by being positioned in said holes (1.1) through the lower and/or upper ends, a base (2.2) that extends outwards from the lower end of said holder strut (2.1) and to which the fan blade is positioned and a reclining component (2.3) that extends outwards from the upper end of said holder strut (2.1) and to which the upper portion of the fan blade is positioned and/or reclined.

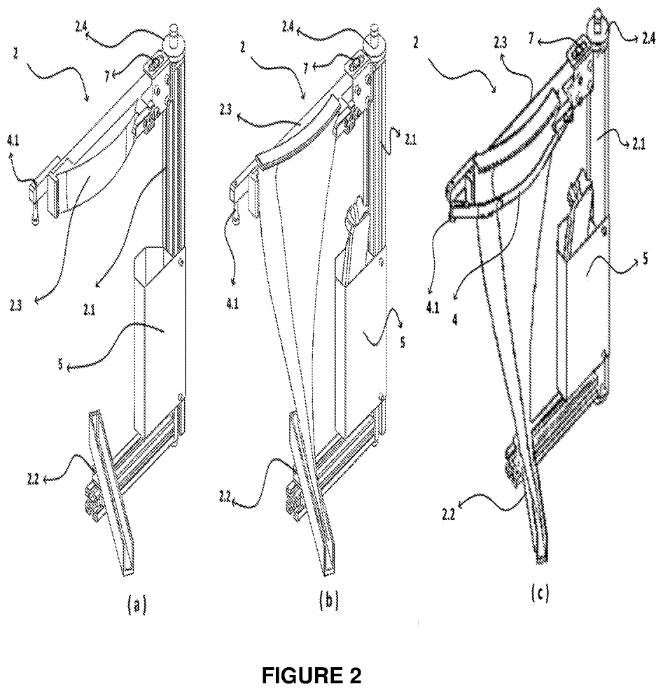

Since the lower and/or upper ends having a shaft shape of said holder strut (2.1) are directly inserted in the holes (1.1) and said base (2.2) and the reclining component (2.3) are fastened vertically to said holder strut (2.1) in a horizontal axis, holders (2) is able to swivel independently from each other. Protrusions having a cylindrical shaft shape that protrudes from the lower and/or upper end of the holder strut (2.1) operate independently from another holder (2) in each hole (1.1) with the same diameter. Each holder (2) comprises its rotation axis due to said holes (1.1). Holders (2) are ensured to rotate through a hinge-like structure at the bottom and top. This axis is designed such that it is arranged preferably annularly around the carrier center. Holders (22) are preferably arranged annularly and 22 units thereof are unit for IAE V2500 motor. As can be seen in FIG. 2, said base (2.2) is comprised of a vertical component and an angular component mounted to the end portion of said vertical component. Said angular component is moved in the vertical component, and since it is spirally curved as much as the blade width of the fan blade, it can be adjusted according to its resulting depth. In the present invention, there are separate holders (2) for each fan blade, and said holders (2) is able to swivel angularly independent from each other.

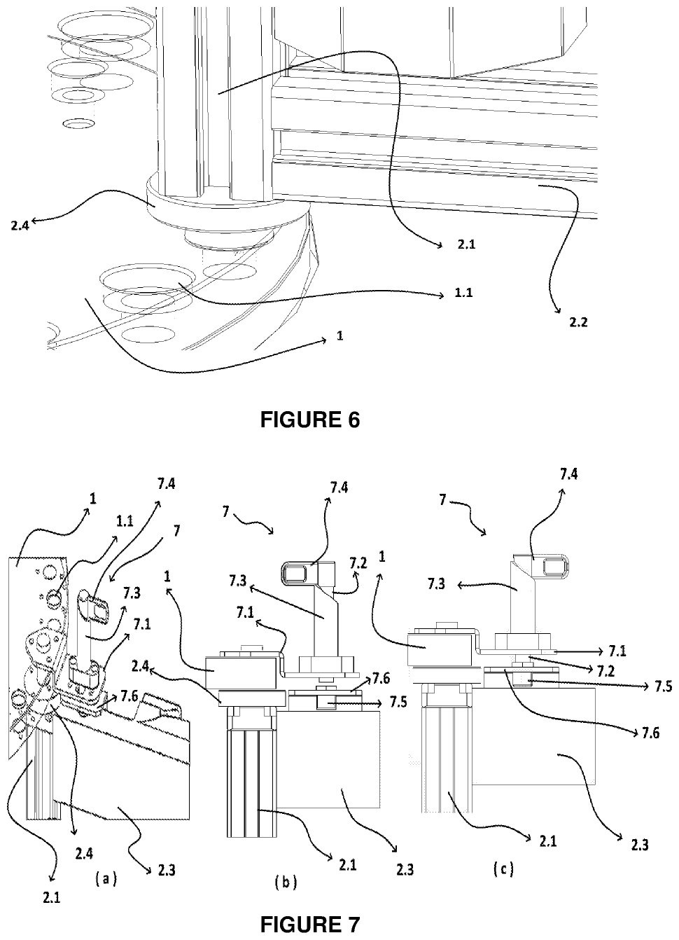

In a preferred embodiment of the present invention, there is a joint (2.4) that avoids abrasion that is to occur while the holder strut (2.1) swivels independently, by positioning said holder strut (2.1) between its lower and/or upper ends and said holes (1.1). Said joint (2.4) also has the same geometry as the lower and/or upper ends of the holder strut (2.1) and can be inserted in said hole (1.1). That is to say, it protrudes outwards in a cylindrical shaft shape. FIG. 6 shows this embodiment.

In a preferred embodiment of the present invention, there may be a perforated block (3.1) that comprises a shelf (3) section to place user's hand tools and components of the fan blade and also gaps thereon to place bolts to be removed and/or tightened on said shelf (3) section, such that it is designed on said mast (1). The invention may preferably comprise 3 tier shelf (3) section.

In another embodiment of the present invention, since the belt hanger (4.1) at the end portion of said reclining component (2.3) and the reclining component (2.3) circle around said belt hanger (4.1) starting from the end close to said holder strut (2.1) and indexed on itself, it comprises a snap-fastener belt (4) to fasten the fan blade that is fixed to the movable holder (2). FIG. 2 shows the indexing of said belt (4).

In another embodiment of the present invention, it may comprise a pocket (5) that allows for carrying and piling up mating components that are necessary to mount and/or demount the fan blades, such that it is on said holder strut (2.1).

In another preferred embodiment of the present invention, it comprises a lower plate (6) positioned under the mast (1) such that there will be a distance between said mast (1) and it, the wheel (6.1) allowing for a movement by being positioned under said lower plate (6) and a handle (6.2) allowing the user for directing the lower plate (6) by extending outwards from said lower plate (6). Thus, the carrier can be moved and be used in a portable manner.

In conclusion, in a preferred embodiment of the present invention, it comprises an indexing mechanism allowing the fan blades for being firmly fastened by engaging said reclining component (2.3) with the mast (1), which comprises an index shaft mounting component (7.1) having a gap thereon, one end of which is fastened on said mast (1) and the other end of which extends towards said reclining component (2.3), an index shaft (7.2) that extends towards the reclining component (2.3) by passing through the gap on said index shaft mounting component (7.1), an index shaft mechanism (7.3) positioned such that it faces upwards from the space on said index shaft mounting component (7.1), which determines, how long the index shaft (7.2) therein descends by means of the angle obtained ensuring that one edge of its upper portion is low and the other edge is relatively higher and thus, whether the indexing process is to be performed or not, an index head (7.4) positioned on the upper end of said index shaft (7.2), which carries out the indexing and unindexing process by drawing said index shaft mechanism (7.3) towards its lower and higher edges, an index shaft housing mounting component (7.6) engaged to said reclining component (2.3) such that its gap thereon superposes the gap on the index shaft mounting component (7.1), which thereby carries out the indexing process, when the index shaft (7.2) is released in the downward direction and an index shaft housing (7.5) positioned to the lower wall, in which said index shaft (7.2) is placed, when released in the downward direction in the gap on said index shaft housing mounting component (7.6). Each holder (2) may be indexed separately by the index mechanism (7) thereon and its normal positions are those indexed positions. FIG. 7 shows the operation of the pin structure. While said index head (7.4) is on the higher edge of the index shaft mechanism (7.3), the indexing process cannot be performed due to the length of the index shaft (7.2), however, when the index head (7.4) is brought to the relatively lower edge of the index shaft mechanism (7.3), the indexing process is performed such that the index shaft (7.2) is inserted in the index shaft housing (7.5) on said index shaft housing mounting component (7.6).

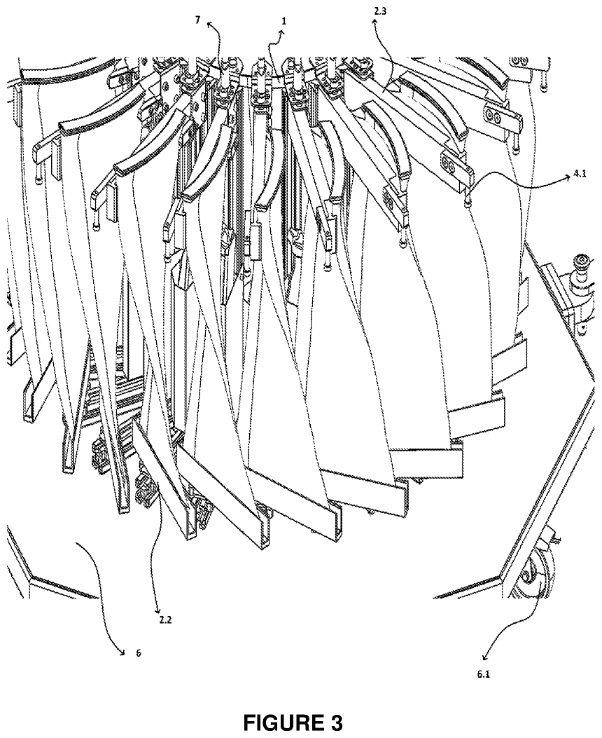

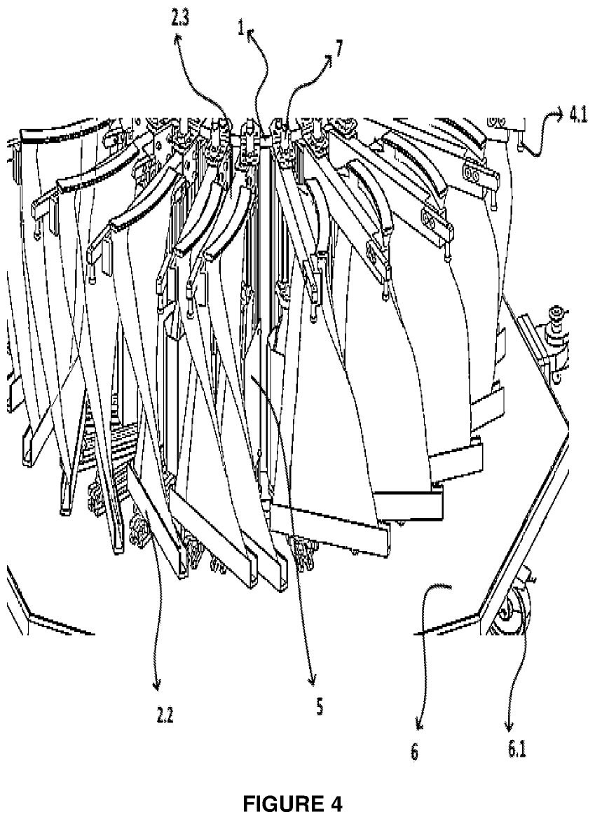

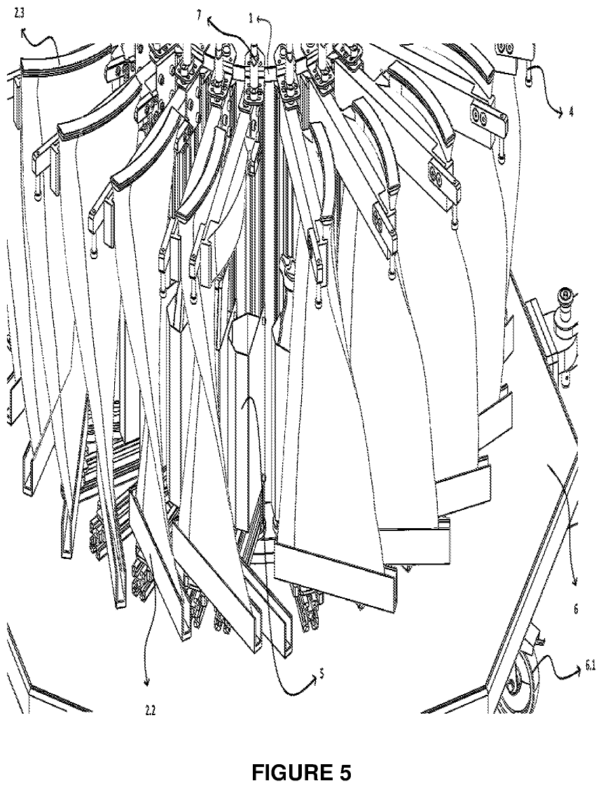

The fan blades being copies of each other may be carried and piled up being held to each other in close proximity by means of said carrier embodiment. When the fan blades are held close to each other, they will cover less space. However, due to their geometry, there should be a distance between it and other blades to take one of the blades. It is possible by means of the present invention to take the desired fan blade out of other blades and to place a fan blade in other blades. FIGS. 3, 4, and 5 show the fan blade. When desired to load or take a fan blade, the holder (2) is unindexed and the holder (2) is moved to the desired position by rotating in a few degrees. If a loading process is to be performed, the fan blade is fastened to the holder (2) by means of a snap-fastener belt (4) after its placement. If an unloading process is to be performed, the snap-fastener belt (4) is unfastened and released from the holder (2) and the fan blade is unloaded. Afterward, the holder (2) is brought manually to its normal position and fastened by means of the index mechanism. In other words, the holder (2) is normally fastened to the center position through an index mechanism (7). The holder (1) is moved to the left by unindexing said index mechanism (7) during the loading and unloading process and the fan blade may be easily unloaded and positioned. When the index mechanism (7) of holders (2) are unindexed, they achieve mobility of 5-10 degree. If we give an example to provide a better understanding of the present invention, the aim is to draw back the hanger and open a window, while choosing clothing in a shop. The index mechanism (7) is unindexed and the hanger and window are moved angularly and indexed. The fan blade can be demounted-mounted from-to the holder (2) by means of the angular gap resulting from moving the holder (2) slightly. It is formed said angular gap in FIG. 4 for the fan blade positioned to the holder (2) in FIG. 2 and it is demounted from the holder (2) in FIG. 5. Furthermore, these Figures also show, how said dead space is used.

It is predictable to those skilled in the art that these holders (2) move linearly and constitute no surprising effect, in the presence of holders (2) that can swivel independent from each other, in other words, move angularly in the present invention. Because it can be easily achieved by forming gaps in various geometries at the connection points of linear movement elements to each other. Furthermore, it can be achieved through a simple technical development that holders (2) preferably arranged annularly are in a form such as square and rectangle again regarding the invention and Figures.

Thus, it has been provided a carrier with movable fan blade holders (2) and alternative embodiments thereof that can swivel independently in the vertical axis so as to carry and pile up the fan blades and mating parts to be removed from engines or to be mounted thereto during performing maintenance of aircraft engines or repairing process.

1. Carrier for carrying and piling up the fan blades demounted from aircraft engines or to be mounted to the engine, characterized by comprising; at least one holder (2), to which the fan blades are fastened, that comprises the following:
at least one mast (1) that is comprised of at least two superposed plates and maintains the carrier vertically,
at least one hole (1.1) bored on plates of said mast(1),
at least one holder strut (2.1) that can swivel independently in the holes (1.1) by being positioned in said holes (1.1) through lower and/or upper ends,
at least one base (2.2) that extends outwards from the lower end of said holder strut (2.1) and to which the lower portion of the fan blade is positioned,
at least one reclining component (2.3) that extends outwards from the upper end of said holder strut (2.1) and to which the upper portion of the fan blade is positioned.

2. A carrier according to claim 1, characterized by comprising; at least one joint (2.4) that avoids abrasion that is to occur while the holder strut (2.1) swivels independently, by positioning said holder strut (2.1) between its lower and/or upper ends and said holes (1.1).

3. A carrier according to any one of the preceding Claims, characterized by comprising the following;
a shelf (3) section forming a space to place user's hand tools and components of the fan blade, such that it is designed on said mast (1),
at least one perforated block (3.1) having space thereon to place bolts to be removed and/or tightened, such that it is designed on said shelf (3) section.

4. A carrier according to claim 1, characterized by comprising the following;
at least one belt hanger (4.1) at the end portion of said reclining component (2.3),
at least one snap-fastener belt (4) that allows for circling around said belt hanger (4.1) starting from the end close to said holder strut (2.1) of the reclining component (2.3) and fastening the fan blade positioned to the movable holder (2) by means of being indexed thereon.

5. A carrier according to claim 1, characterized by comprising; at least one pocket (5) that allows for carrying and piling up mating components that are necessary to mount and/or demount the fan blades, such that it is on said holder strut (2.1).

6. A carrier according to claim 1, characterized by comprising; the following;
at least one lower plate (6) positioned under the mast (1) such that there will be a distance between said mast (1) and it,
at least one wheel (6.1) allowing for a movement by being positioned under said lower plate (6),
at least one handle (6.2) allowing the user for directing the lower plate (6) by extending outwards from said lower plate (6).

7. A carrier according to claim 1, characterized by comprising; at least one index mechanism (7) allowing the fan blades for being firmly fastened by engaging said reclining component (2.3) with the mast (1), which comprises the following:
at least one index shaft mounting component (7.1) having a gap thereon, one end of which is fastened on said mast (1) and the other end of which extends towards said reclining component (2.3),
at least one index shaft (7.2) that extends towards the reclining component (2.3) by passing through the gap on said index shaft mounting component (7.1),
at least one index shaft mechanism (7.3) positioned such that it faces upwards from the space on said index shaft mounting component (7.1), which determines, how long the index shaft (7.2) therein descends by means of the angle obtained ensuring that one edge of its upper portion is low and the other edge is relatively higher and thus, whether the indexing process is to be performed or not,
at least one index head (7.4) positioned on the upper end of said index shaft (7.2), which carries out the indexing and unindexing process by drawing said index shaft mechanism (7.3) towards its lower and higher edges,
at least index shaft housing mounting component (7.6) engaged to said reclining component (2.3) such that its gap thereon superposes the gap on the index shaft mounting component (7.1), which thereby carries out the indexing process when the index shaft (7.2) is released in the downward direction,
at least one index shaft housing (7.5) positioned to the lower wall, in which said index shaft (7.2) is placed when released in the downward direction in the gap on said index shaft housing mounting component (7.6).
